(19) United States
(12) Patent Application Publication
(10) Pub. No.: US 2020/0080622 A1
(43) Pub. Date: Mar. 12, 2020

(54) Mower Deck Drive Belt Displacement Dampening System

(71) Applicant: RF Products, Inc., Batesville, AR (US)

(72) Inventor: Robert N. Foster, Batesville, AR (US)

(21) Appl. No.: 16/127,987

(22) Filed: Sep. 11, 2018

(51) Int. Cl. F16H 7/12; A01D 34/66; A01D 34/76; A01D 34/82; A01D 69/00

(52) U.S. Cl. CPC F16H 7/1236; A01D 34/66; A01D 2101/00; A01D 34/82; A01D 69/002; A01D 34/76

(57) ABSTRACT

A system providing a drive belt with optimal tension to reduce flapping and other displacement movements relative to the pulley wheels. Included is a coil spring biasing the idler arm and its idler pulley wheel) in alignment to maintain the desired amount of tautness in the belt. Also included is a fluid spring mechanism that resists movement of the idler arm until such resistance is overcome by the coil spring.

### CROSS REFERENCE TO RELATED APPLICATIONS

Not applicable.

### FEDERALLY SPONSORED RESEARCH AND DEVELOPMENT

Not applicable.

### MICROFICHE APPENDIX

Not applicable.

### BACKGROUND OF THE INVENTION

### 1. Field of the Invention

The present disclosure relates to the field of pulley system drive belt tensioners. More particularly, the invention disclosed herein relates to systems dampening the flapping of drive belts, and the displacement of drive belts from the pulley system. The present invention relates especially to the drive belt pulley systems of mower decks of riding mowers, although it may be applied to power take-off systems of other vehicles as well.

### 2. Background of Invention

Many riding mowers have one or more rotating blades powered by a taut belt traveling around pulley wheels interfacing with the inner surface of the belt. Often, the movement of the belt is powered by a motorized drive shaft, mechanically interfacing with a drive pulley within the pulley system.

Forces exerted upon the belt by the motor-powering, or by changes in resistance to the rotation of the blades, may cause disfigurement or displacement of the belt relative to the pulleys. For a system having the belt oriented vertically, traveling around pulleys arranged on substantially the same horizontal plane, the belt may be displaced along that horizontal plane so that its tautness varies along the belt-circuit around the pulleys. Sometimes the displacement occurs rapidly in alternating directions, resembling vibrations or back-and-forth fluttering or flapping of the belt. In extreme cases, the belt may actually be displaced entirely from a pulley wheel, thereby stopping the travel of the belt and the consequent powering of the blade(s) or other apparatus being powered by the belt.

To reduce or prevent such belt displacement, often included in the pulley system is at least one tensioning mechanism, for adjusting and/or maintaining the tautness of the belt. Often such a tensioning mechanism is at least one pulley wheel interfacing with the outer side of the belt (between nearby pulley wheels), having an axle that may be moved closer or further to the belt as needed to adjust or maintain the tautness. Sometime the tensioning pulley's axle is carried on a pivoting arm called an idler arm.

Idler arms positionally biased by an extension spring are known in the field. U.S. Pat. No. 7,913,479 issued to Eavenson discloses a two-pulley belt tensioning mechanism including an idler arm (on the “slack” side of the drive pulley) having a centrally located pivotal attachment to the mower deck, with a pulley on each side of the pivot point (the first against the inner side of the drive belt and the second against the outer side of the drive belt). The idler arm also includes a spring (or air or hydraulic tensioning device) biasing the first pulley against the inner side of the drive belt. The drive belt loops around (and drives) a double stacked pulley, one of which likewise drives a secondary drive belt having a secondary idler pulley pivotally connected to the deck and spring biased to increase tension of the secondary drive belt by rotating the pulley arm against the outer side of the secondary belt.

However, often belt tensioning mechanisms that are positionally biased merely by an extension spring are inadequate in preventing displacement of the belt that causes stoppage. Accordingly, there is a need for additional mechanisms for preventing such belt displacement. At this time, no known prior art discloses a secondary system dampening the pivoting of the idler arm in either direction in reaction to load being exerted upon the belt system, or in reaction to the force exerted by the spring.

### BRIEF SUMMARY OF THE INVENTION

The invention is essentially a system for dampening the displacement of a drive belt during use, essentially involving an extension spring and a gas shock (or gas spring) that reduces displacement (flapping) of the drive belt when operational “load” or other destabilizing force is applied to the drive belt. The extension spring biases the orientation of an idler arm in the resting-state alignment, whereas the gas shock resists misalignment caused by pivoting of the idler arm in either direction. In most general terms, the invention disclosed herein comprises a system that reduces the displacement of a drive belt such as that which powers the blade(s) of a mower (especially a riding mower), which significantly maintains the consistency of the blade rotation and significantly reduces the prospects that the drive belt will be displaced from one of the pulleys in the drive train (and thereby cause mowing stoppage).

### BRIEF DESCRIPTION OF FIGURES OF THE DRAWINGS

FIG. 1 depicts a perspective view from beneath a representative sample of a riding mower (in phantom) showing the drive pulley connected to the drive shaft, and the drive belt encircling the drive pulley and leading to the mower deck.

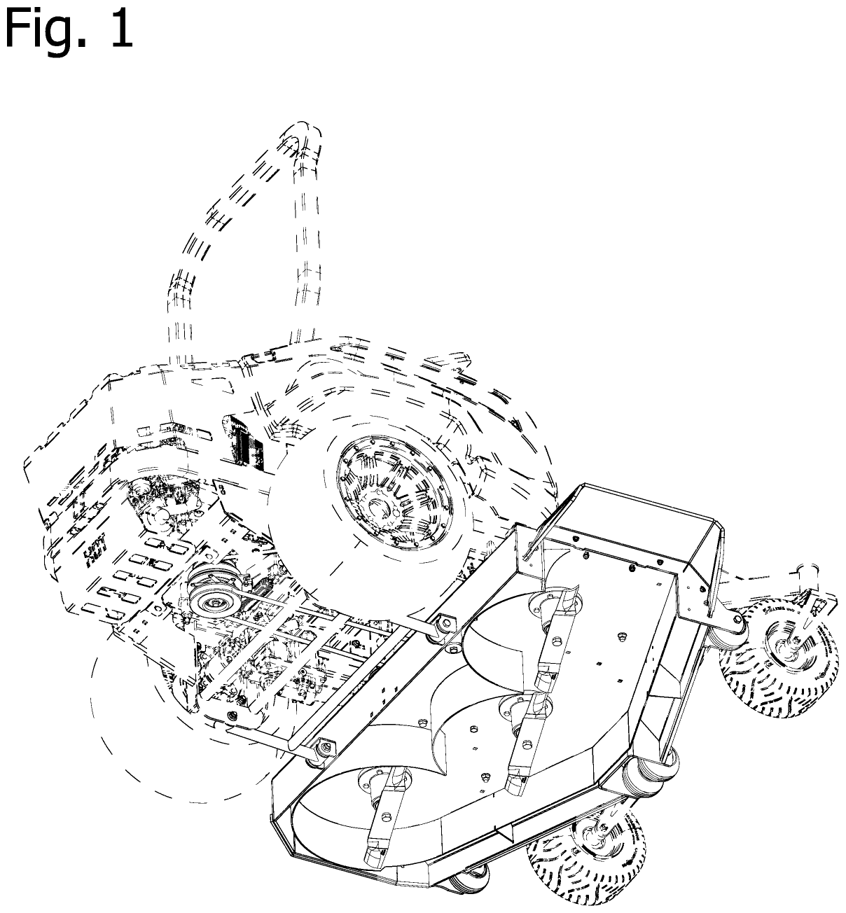

FIG. 2 depicts a perspective view of the mower deck and drive pulley assembly of the riding mower of FIG. 1 as the deck's drive train appears with the clutch disengaged; included is a belt (2) travelable around a circuit comprising a drive pulley (3) atop a clutch mechanism (not shown), an idler arm (101) carrying an idler pulley (201), a plurality of blade drive pulleys (501, 701, 801), an extension spring and a gas shock.

FIG. 3 depicts a top plan view of the mower deck and its drive train of FIG. 2, as it appears with the clutch disengaged from the drive pulley; note the parallel positioning of the spring and gas shock's cylinder, and the length of the piston rod outside of the cylinder.

FIG. 4 depicts another top plan view of the mower deck and drive train of FIG. 1, but at the approximate moment that the clutch causes engagement of the drive shaft to the drive pulley so that the belt begins rotating in a clockwise direction; note the non-parallel positioning of the spring and gas cylinder, and the shorter length of the piston rod (407) outside of the cylinder (403), and the positioning of the belt relative to the idler pulley.

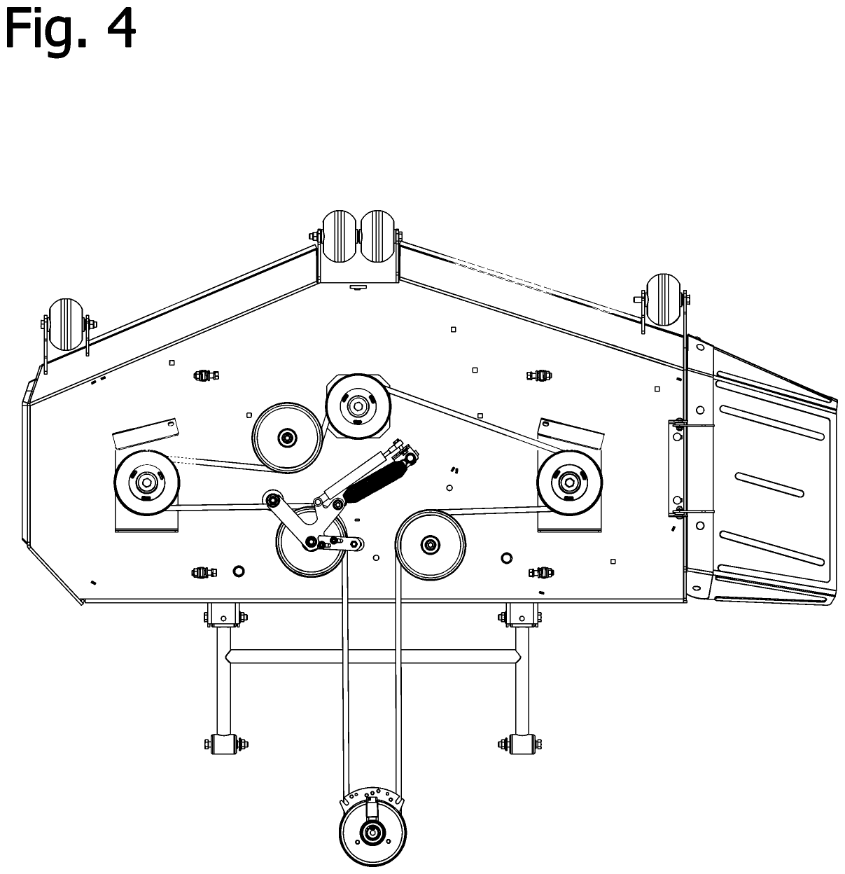

### DETAILED DESCRIPTION OF THE INVENTION

The terminology used herein is for the purpose of describing particular embodiments only, and is not intended to be limiting. As used herein, the singular forms “a”, “an”, and “the” are intended to include the plural forms as well, unless the context clearly indicates otherwise. It will be further understood that the terms “comprising”, “including” or “having”, or any derivative thereof, when used in this specification, specify the presence of stated features, regions, integers, steps, operations, elements, and/or components, but do not preclude the presence or addition of one or more other features, regions, integers, steps, operations, elements, components, and/or groups thereof.

For the sake of simplicity and to give the claims of this patent application the broadest interpretation and construction possible, the conjunctive “and” may also be taken to include the disjunctive “or,” and vice versa, whenever necessary to give the claims of this patent application the broadest interpretation and construction possible. Likewise, when the plural form is used, it may be taken to include the singular form, and vice versa.

It will be understood that, although the terms first, second, third, etc. may be used herein to describe various elements, these elements should not be limited by these terms. These terms are only used to distinguish one element from another element.

The term “gas shock” can mean any device using the flow and/or compression of any fluid (gas or liquid) to provide resistance to the movement of a piston rod and/or a cylinder enclosing the fluid and accepting the piston rod; for example, “gas shock” may include a gas shock or similar pneumatic mechanism and/or a hydraulic cylinder or similar hydraulic mechanism.

The disclosure herein is not limited by construction material(s) to the extent that such materials satisfy the structural and/or functional requirements. For example, any material may be used so long as it satisfies the rigid, resilient and/or durable structural and functional requirements for which it is being used.

It is an object of the present invention to provide a drive belt tensioning system that improves the dampening of drive-belt vibration.

Another object of the invention is to provide a drive belt tensioning system that improves the dampening of drive-belt vibration while reducing the risk that the belt will escape from a pulley along its route along the drive train.

Another object of the invention is to provide a belt tensioning system having a secondary system resisting or prevent misalignment of the tensioning system away from its alignment providing optimal or desired tautness of the drive belt.

Other objects of the invention will become clear upon a review of the disclosure herein.

The basic elements of the invention encompass a system dampening the displacement of a belt driven around a circuit of pulley wheels on a chassis (or mower deck) by a motor having a motorized drive shaft with a clutch engageable with the drive pulley powering the belt. I general, the dampening system comprises:

(a) an idler arm having an anchor point pivotally anchored to the deck, an axle end carrying an idler pulley wheel, an alignor connection point and a resistor connection point;

(b) an extension spring for aligning the idler arm in a preferred orientation absent any engagement between the pulley drive and the clutch, pivotally connected to the alignor connection point at its first end and attached to the deck at its second end; and

(c) a gas piston rod spring for resisting any misalignment of the idler arm, pivotally connected to the resistor connection point at its first end and attached to the deck at its second end.

The prototype tensioning system is deployed on a riding lawnmower, having the three blades of the mower deck powered by a belt that is driven by the drive shaft of the engine when the power takeoff clutch causes engagement with the drive pulley. That engagement moment commences one source of drive belt displacement. Displacement of a different sort occurs, for example, when the rotating mower blades encounter higher or thicker grass during mowing. Changes in terrain and the mowing environment result in a variety of different “tensions” applied to the drive belt, which causes drive belt flapping . . . back and forth, primarily in a horizontal plane. Sometimes the flapping becomes so pronounced that the belt is displaced from its channel on the circumference of a pulley wheel, thereby disrupting the mechanical linkage between the drive shaft to the blades so that the power to the blades is interrupted. Even if the belt is not thrown from the pulley wheel, the flapping causes variation in the powering of the mower blades, diminishing the effectiveness of the mower; it also causes unwanted vibration of the mower deck.

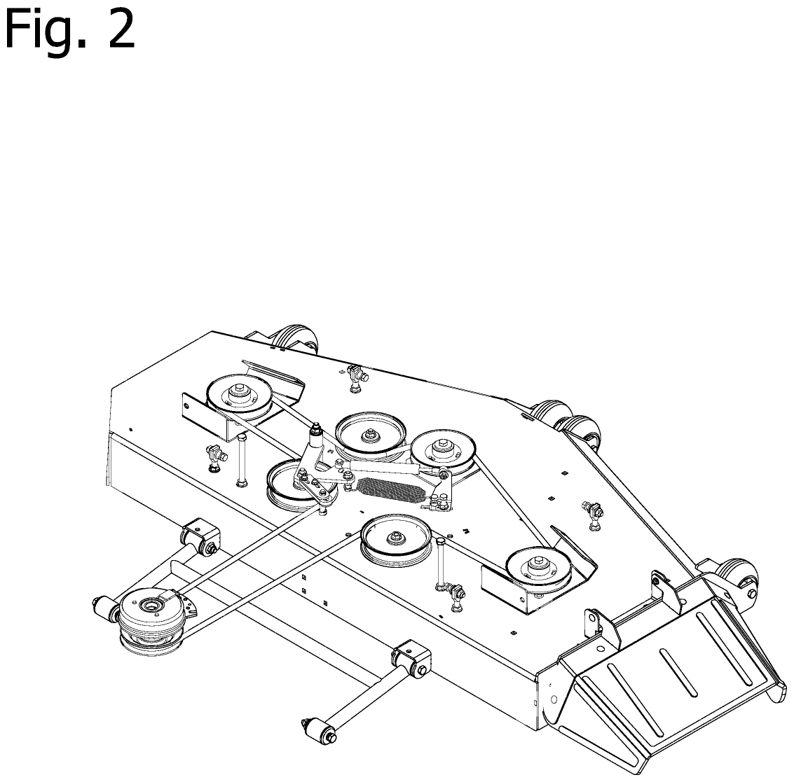

FIG. 2 shows an idler arm (101) having a pivot point (103) pivotally anchored to the deck (1). The idler harm has an axle end (105) carrying an idler pulley wheel (201); it also includes an alignor connection point or end (107) and a resistor connection point or end (109). Also shown is an alignor (301) such as an extension spring, for pulling the idler arm (and idler pulley) into alignment in a preferred orientation absent any engagement between the drive pulley (3) and the clutch (not shown). The alignor's first end (303) is pivotally connected to the alignor connection point (107) of the idler arm, and attached to the deck at its second end (305). FIG. 2 also shows a resistor such as a gas shock, having a piston rod (407) telescopically movable within a cylinder (403) in accordance with the fluid compression or fluid flow characteristics of the assembly; the resistor's first end (405) is pivotally connected to the resistor connection point (109) of the idler arm, and the resistor's second end (409) is attached to the deck. The resistance of movement of the cylinder in relation to the piston rod likewise resists pivoting of the idler arm.

Motive force is imparted to the drive belt, when the clutch engages the drive pulley around which the drive belt travels. Before the clutch is engaged, there is no motive force applied to the drive belt, so that the drive belt (and system of drive train pulleys around which it travels) is in a resting-state configuration (FIG. 2). Ideally the drive belt remains snugly within the channel around the perimeter of the drive pulley (3), and the channels around the perimeters of all other pulleys within the drive train system. FIG. 2 shows an idler pulley wheel (201), a first blade drive pulley (501), a first tensioning pulley (601), a second blade drive pulley (701), third blade drive pulley (801), and a second tensioning pulley (901). Ideally the drive train pulleys provide the drive belt with the optimum tension to keep it properly engaged with the drive pulley while motive force is imparted, and minimize displacement of the drive belt relative to the pulleys.

The extension spring aligns the idler arm and idler pulley wheel in a configuration to maintain the desired amount of tautness of the belt around the pulley wheels. Absent any engagement between the drive pulley and the clutch, the gas shock resists any pivoting of the idler arm away from the configuration to maintain the desired amount of tautness of the belt around the pulley wheels. The pneumatic properties of the gas shock piston rod telescopically received within the cylinder resists movement of the cylinder relative to the the piston rod.

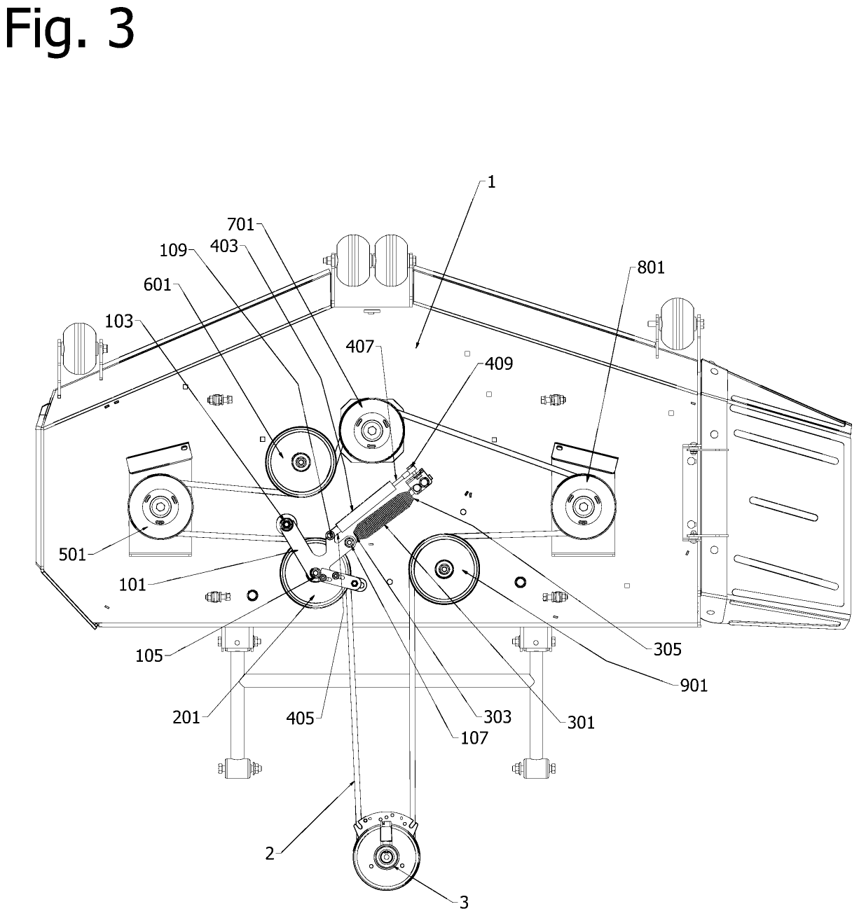

Engagement of the drive shaft and the drive pulley immediately imparts motive force to the belt by rotating the drive pulley. For a belt driven in a clockwise direction around the pulley system (viewed from above as in FIG. 3), it is observed that, at the moment of engagement, the idler arm is moved toward the front of the mower deck (toward the top of the sheet of drawings). It then may move back and forth until eventually reaching a relative equilibrium (absent application of different “load” forces or tensions to the belt). The addition of the gas shock beside the extension spring greatly reduces the amplitude of the back-and-forth pivoting of the idler arm, and results in equilibrium much quicker that without having a secondary resistance element such as the gas shock. After engagement between the drive shaft and the drive pulley, the pneumatic properties of the gas shock's piston rod telescopically received within the cylinder resists movement of the cylinder relative to the piston rod and, once so moved, resists additional movement of the cylinder until the resistance is overcome by the extension spring.

In general, the invention disclosed herein includes (comprises) a system dampening the displacement of a belt forming a circuit around a vehicle's pulley wheels and a drive pulley powered by a motor having a motorized drive shaft with a clutch mechanism for engagement of the drive shaft with the drive pulley. The dampening system may include:

(a) an idler arm having a pivot point pivotally anchored to a first anchor point on the vehicle, an axle end carrying the idler pulley wheel, an alignor connection point and a resistor connection point;

(b) a means of aligning the idler arm in a preferred alignment, the means of aligning the idler arm being pivotally connected at a first end to the alignor connection point and attached at a second end to a second anchor point on the vehicle; and

(c) a means of resisting misalignment of the idler arm, pivotally connected at a first end to the resistor connection point and attached at a second end to a third anchor point on the vehicle.

The means of aligning the idler arm may include a coil spring.

The means of resisting misalignment of the idler arm may include a gas shock. The first end of the gas shock may include a gas-filled cylinder, and the second end of the gas shock may include a piston rod telescopically received within the cylinder. An alternative arrangement may also be used, with the first end of the gas shock including a piston rod and the second end including a cylinder.

Absent any motor-powering of the drive pulley, the coil spring aligns the idler arm and idler pulley wheel in the alignment to maintain the desired amount of tautness of the belt around the circuit. Absent any motor-powering of the drive pulley, the gas shock prevents substantial pivoting of the idler arm away from the alignment to maintain the desired amount of tautness of the belt around the circuit. Upon initiation of motor powering of the drive pulley, the pneumatic properties of the gas shock resist movement of the cylinder relative to the piston rod until the resistance is overcome by the coil spring. Typically, such movement is of the cylinder toward the piston rod, essentially enveloping more of the piston rod within the cylinder. And once the cylinder is moved toward the piston rod, the gas shock resists movement of the cylinder away from the piston rod until the resistance is overcome by the coil spring.

Upon initiation of force applied in opposition to the motor-powering, such as by encountering high grass during mowing, the pneumatic properties of the gas shock resist movement of the cylinder relative to the piston rod until the resistance is overcome by the coil spring. And once the cylinder is moved away from the piston rod (essentially leaving a greater length of the piston rod exposed outside the cylinder), the gas shock resists movement of the cylinder toward the piston rod until the resistance is overcome by the coil spring.

A more particular embodiment of the invention is a system dampening the displacement of a belt forming a circuit around a mower's pulley wheels and a drive pulley powered by a motor having a motorized drive shaft with a clutch mechanism for engagement of the drive shaft with the drive pulley. The dampening system may include:

(a) an idler arm having a pivot point pivotally anchored to a first anchor point on the mower, an axle end carrying an idler pulley wheel, an alignor connection point and a resistor connection point;

(b) a coil spring pivotally connected at its first end to the alignor connection point and attached at its second end to another anchor point on the mower, for aligning the idler arm in a preferred alignment; and

(c) a gas shock pivotally connected at its first end to the resistor connection point and pivotally connected at its second end to a third anchor point on the mower.

Absent any motor-powering of the drive pulley, the coil spring aligns the idler arm and idler pulley wheel in the alignment to maintain the desired amount of tautness of the belt around the pulley wheels. The gas shock prevents substantial pivoting of the idler arm away from the alignment to maintain the desired amount of tautness of the belt around the circuit.

Upon the initiation of motor-powering of the drive pulley to start the rotation of the mower blades, the pneumatic properties of the gas shock resist movement of the cylinder toward the piston rod until the resistance is overcome by the coil spring.

Upon the initiation of force applied in opposition to the motor-powering, the pneumatic properties of the gas shock resist movement of the cylinder toward the piston rod until the resistance is overcome by the coil spring.

It should be recognized, particularly by those skilled in the art, that differences in the structures described may be adopted, without a material change in the function or operation of the vehicle, or departure from the disclosed invention as described in the accompanying claims.

I claim:

1. A system dampening the displacement of a belt forming a circuit around a vehicle's pulley wheels and a drive pulley powered by a motor having a motorized drive shaft with a clutch mechanism for engagement of the drive shaft with the drive pulley, said dampening system comprising:
(a) an idler arm having a pivot point pivotally anchored to a first anchor point on the vehicle, an axle end carrying the idler pulley wheel, an alignor connection point and a resistor connection point;
(b) a means of aligning said idler arm in a preferred alignment, said means of aligning said idler arm being pivotally connected at a first end to said alignor connection point and attached at a second end to a second anchor point on the vehicle; and
(c) a means of resisting misalignment of said idler arm, pivotally connected at a first end to said resistor connection point and attached at a second end to a third anchor point on the vehicle.

2. A belt displacement dampening system described in claim 1, said means of aligning said idler arm comprising a coil spring.

3. A belt displacement dampening system described in claim 1, said means of resisting misalignment of said idler arm comprising a gas shock.

4. A belt displacement dampening system described in claim 3, said first end of said gas shock comprising a gas-filled cylinder, and said second end of said gas shock comprising a piston rod telescopically received within said cylinder.

5. A belt displacement dampening system described in claim 4 wherein, absent any motor-powering of the drive pulley, said coil spring aligns said idler arm and idler pulley wheel in said alignment to maintain the desired amount of tautness of the belt around the circuit.

6. A belt displacement dampening system described in claim 4 wherein, absent any motor-powering of the drive pulley, said gas shock prevents substantial pivoting of said idler arm away from said alignment to maintain the desired amount of tautness of the belt around the circuit.

7. A belt displacement dampening system described in claim 4 wherein, upon initiation of motor powering of the drive pulley, the pneumatic properties of said gas shock resist movement of said cylinder relative to said piston rod and, once said cylinder is moved toward said piston rod, said gas shock resists movement of said cylinder away from said piston rod until said resistance is overcome by said coil spring.

8. A belt displacement dampening system described in claim 7 wherein, upon initiation of force applied in opposition to said motor-powering, the pneumatic properties of said gas shock resist movement of said cylinder relative to said piston rod and, once said cylinder is moved away from said piston rod, said gas shock resists movement of said cylinder toward said piston rod until said resistance is overcome by said coil spring.

9. A system dampening the displacement of a belt forming a circuit around a mower's pulley wheels and a drive pulley powered by a motor having a motorized drive shaft with a clutch mechanism for engagement of the drive shaft with the drive pulley, said dampening system comprising:
(a) an idler arm having a pivot point pivotally anchored to a first anchor point on the mower, an axle end carrying an idler pulley wheel, an alignor connection point and a resistor connection point;
(b) a coil spring pivotally connected at its first end to said alignor connection point and attached at its second end to another anchor point on the mower, for aligning said idler arm in a preferred alignment; and
(c) a gas shock pivotally connected at its first end to said resistor connection point and pivotally connected at its second end to a third anchor point on the mower;
wherein, absent any motor-powering of the drive pulley, said coil spring aligns said idler arm and idler pulley wheel in said alignment to maintain the desired amount of tautness of the belt around the pulley wheels; and said gas shock prevents substantial pivoting of said idler arm away from said alignment to maintain the desired amount of tautness of the belt around the circuit.

10. A belt displacement dampening system described in claim 9 wherein, upon the initiation of motor-powering of the drive pulley to start the rotation of the mower blades, the pneumatic properties of said gas shock resist movement of said cylinder toward said piston rod until said resistance is overcome by said coil spring.

11. A belt displacement dampening system described in claim 10 wherein, upon the initiation of force applied in opposition to said motor-powering, the pneumatic properties of said gas shock resist movement of said cylinder toward said piston rod until said resistance is overcome by said coil spring.
